(19) United States
(12) Patent Application Publication
(10) Pub. No.: US 2004/0085999 A1
(43) Pub. Date: May 6, 2004

(54) Method and apparatus for selective segmentation and reassembly of asynchronous transfer mode streams

(76) Inventors: Charles James Burnett, Colorado Springs, CO (US); Alan Paul Huff, Colorado Springs, CO (US); Scott Blomquist, Colorado Springs, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/285,717

(22) Filed: Oct. 31, 2002

(51) Int. Cl. H04J 3/24; H04L 12/56

(52) U.S. Cl. 370/474; 370/250

(57) ABSTRACT

A method for testing a data network comprises the steps of establishing one or more stream identifiers for reassembly, receiving a cell, and parsing the cell to obtain a current stream identifier. One or more message blocks are established in memory and are related to respective ones of the one or more stream identifiers. The message blocks are for receipt of a portion of the cell if the current stream identifier is one of the one or more stream identifiers that are established for reassembly. The method continues with the step of serially writing a portion of the cell into a one of the message blocks related to the current stream identifier. The method repeats the steps of receiving, parsing and serially writing until said message block is complete.

### BACKGROUND

Data networking is a powerful tool in current communication systems. As data networking has matured, data protocol complexities and data rates have increased. Asynchronous Transfer Mode (ATM) networks are one of the prevalent data communication protocols currently in use. ATM is a cell-relay technology that divides, or “segments” upper-level data units into 53-byte cells for transmission over a physical medium. The cells are then “reassembled” back into the upper-level data units for delivery to a final destination. ATM operates independently of the type of transmission being generated at the upper layers and of the type and speed of the physical-layer medium below it. The ATM technology permits transport of transmissions (e.g, data, voice, video, etc.) in a single integrated data stream over any medium, ranging from existing T1/E1 lines to SONET OC-3 at speeds of 155 Mbps and even higher speed media. The basic standards that define ATM are ITU-T I.361, which defines the ATM Layer functions, ITU-T I.363 that defines the ATM Adaptation Layer protocols, and ITU-T I.610, which defines the ATM Operation and Maintenance (“OAM”) and the resource management (“RM”) functions.

An ATM stream is typically full duplex. As such, a first physical link carries in-coming cells and a second physical link carries out-going cells. The term stream is used herein to mean a single overall device-to-device communication identified by a Virtual Path/Virtual Channel (VP/VC) pair in the ATM cell header. Streams are made up of a plurality of messages between devices. Many messages must be segmented into 1 or more 53 byte ATM cells. The data carried by the cells could be a digitally encoded voice conversation, an electronic message, or a digitally encoded video signal.

In order to maintain an ATM data network, it is helpful for a data network test instrument to have the ability to detect and diagnose problems while the network is running at-speed and without having to interrupt data communication traffic. In order to decode and analyze a network protocol running over the ATM network, it is helpful to reconstruct the various ATM messages. Known network test devices perform reconstruction, but achieve the reconstruction by collecting data for some amount of time, halting the data collection process, and then performing the ATM reassembly on the collected data. One difficulty with the post-data collection re-assembly process is that there is little discretion in the data collection process. There is a tremendous amount of data transmitted over an ATM network. Because all test devices have a finite amount of memory for the data collection, the amount of desired data relative to the amount of data available is quite small and the likelihood of collecting data that will reveal the problem during subsequent analysis correspondingly small. If it is known that a problem is occurring only on a few streams, a test operator is forced to collect all data and analyze only the data collected that pertain to the streams of interest. Any problems may only be identified if errors happened to be present in the collected data. Because transmission problems are difficult to predict, there is a need for a data network test instrument to perform data collection and re-assembly continuously and in real-time to better identify and analyze transmission problems when they occur. In order to most efficiently identify and diagnose problems in a data network based upon known network symptoms, there is a further need for a highly flexible and user selectable process for collection and analysis of only those parts of the network data that show network anomalies or reflect the known symptoms. Accordingly, it is beneficial for a single data network tester to be highly configurable in order to view the behavior of the network as a whole and then too isolate and analyze only those portions of the network showing anomalies. Because errors may not reveal themselves at the ATM protocol level, there is a further need for a real-time ATM reassembly capability in a tester and further for reassembly of only streams that are of interest. Real-time reassembly also results in more efficient use of cell/packet capture memory because cell headers only need to be stored once for each reassembled Protocol Data Unit (PDU).

### SUMMARY

According to an embodiment of the present teachings, a method for testing a data network comprises the steps of establishing one or more stream identifiers for reassembly, receiving a cell, and parsing the cell to obtain a current stream identifier. One or more message blocks are established in memory and are related to respective ones of the one or more stream identifiers. The message blocks are for receipt of a portion of the cell if the current stream identifier is one of the one or more stream identifiers that are established for reassembly. The method continues with the step of serially writing a portion of the cell into a one of the message blocks related to the current stream identifier. The method repeats the steps of receiving, parsing and serially writing until said message block is complete, and displays the data in the message block.

According to another aspect of an embodiment of the present teachings an apparatus for testing an asynchronous transfer mode (“ATM”) data network comprises a line interface module, a link layer processor, and a graphical user interface in communication with the link layer processor permitting entry of one or more stream identifiers of interest. A means for receiving a cell, a means for parsing the cell to obtain a current stream identifier, a means for establishing one or more message blocks in memory related to respective ones of the one or more stream identifiers for receipt of a portion of the cell, and a means for serially writing a portion of the cell into a one of the message blocks related to the current stream identifier, and a means for displaying data in the message block.

### BRIEF DESCRIPTION OF THE DRAWINGS

FIG. 1 is an illustration of an ATM data network.

FIG. 2 is a conceptual illustration of ATM network traffic with multiple streams.

FIG. 3 is a block diagram of an embodiment of a test device according to the teachings of the present invention.

FIG. 4 is a block diagram of a line interface module portion of a test device according to the teachings of the present invention.

FIG. 5 is a block diagram of the Field Programmable Gate Array (FPGA).

FIG. 6 is a flow chart of a user input process according to the teachings of the present invention.

FIGS. 7 and 8 represent a flow of a protocol engine according to the teachings of the present invention.

FIG. 9 represents a flow of a buffer write process according to the teachings of the present invention.

FIG. 10 represents a flow of a buffer read process according to the teachings of the present invention.

FIG. 11 represents a flow of an aging process according to the teachings of the present invention.

### DETAILED DESCRIPTION

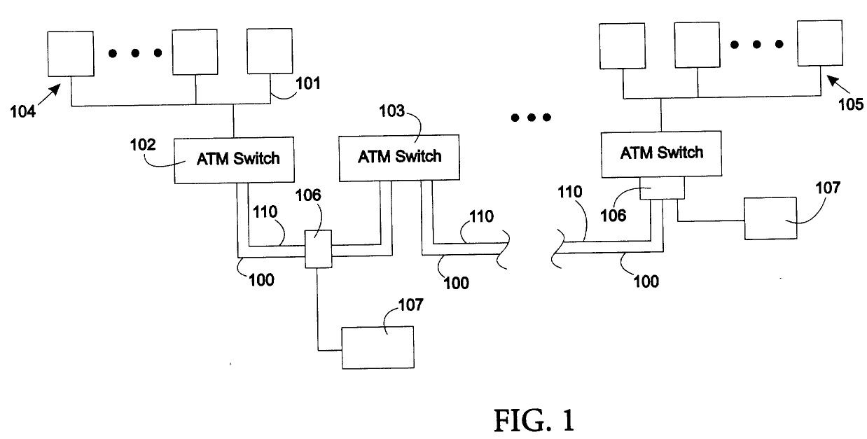

With specific reference to FIG. 1 of the drawings, there is shown an illustration of a representative ATM data network. An ATM network comprises one or more physical cables 100, 110 between first and second ATM switches 102, 103. The physical cables 100, 110 carry electrical or optical data signals to and from the ATM data switches 102, 103. A conventional ATM network is typically a full duplex system that has two dedicated physical cables, one each for the reception 100 and transmission 110 channels. The ATM data switches 102, 103 are often connected to a local network and act as the interface between the ATM network and the local network 104, 105. The ATM data switch 102 or 103 performs segmentation of data from an origination local network 104 into 53 byte cells for transmission across the ATM channel 100 or 110. When the cell reaches a destination ATM switch 103 or 102, the ATM switch 102 or 103 either transmits the cell to a next ATM switch in the circuit or performs reassembly of the cells into a message for presentation to a destination local network 105.

The ATM protocol is capable of transmitting up to approximately 2²⁸ full-duplex streams. In order to administer and reassemble the different streams, an ATM switch assigns a unique stream identifier as part of an ATM segmentation process. The stream identifier comprises two numbers that are referred to as a Virtual Path(“VP”)/Virtual Channel (“VC”) pair. The VP/VC pair is referred to herein as the stream identifier. The stream identifier is placed in the header of the ATM cells that carry data being transferred as part of the stream and provide a mechanism by which the streams are reconciled at the point of reassembly. For ATM Switched Virtual Circuits (SVCs), at some point in time, the stream finishes, the data transfer is complete, and because there is no more data in the stream, the stream identifier is no longer relevant to the communication process. For ATM Permanent Virtual Ciruits (PVCs) the stream does not end, and therefore become irrelevant for testing purposes unless manually removed from the ATM network. There is no indication of that irrelevance sent between the ATM switches.

As a practical matter, there are typically on the order of hundreds of streams active at any one time on a single ATM network. Other streams are inactive and eventually timeout and become irrelevant. Accordingly, as some streams are in the process of timing out, there are on the order of 1500-2000 streams that must be tracked at any one point in time. With this in mind, it is assumed that a test device 107 that is able to track an upper limit of 4096 active streams will be able to adequately handle a worst-case practical scenario. One of ordinary skill in the art appreciates that ATM networks will get faster and be able to accommodate a greater number of streams as technology progresses. Accordingly, the teachings of the present invention may be scaled to accommodate more than the 4096 streams as network and processing capabilities increase.

In order to test an ATM network, a test device probe 106 plugs into the ATM network at any point along its length, either at the cable or cables 100, 110 with a tap or at one or more of the ATM switches 102, 103. Once connected into the network, the probe 106 eavesdrops onto the data traffic without interfering with transmission of the data on the ATM network in any way. Advantageously, the ATM network may operate at-speed and without any accommodation made for the presence of the probe 106. The probe 106 communicates with a test device 107 that receives and processes the data present on the ATM network.

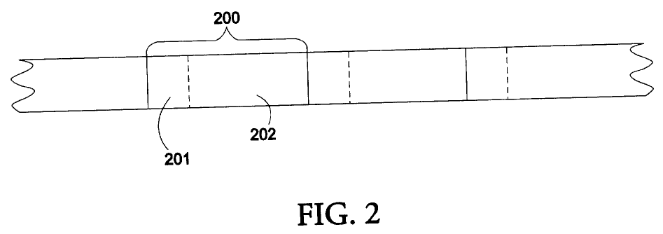

With specific reference to FIG. 2 of the drawings, there is shown a representation of multiple cells 200 present on the ATM network 100, 110. Each cell 200 comprises 53 bytes of information. There are 5 bytes of header 201 and 48 bytes of payload 202. Each cell 200 is part of a unique stream of information. Multiple cells 200 in a single stream comprise a single message block from a source device, such as a computer, to a destination device. For ATM Adpatation Layer 5 (AAL-5) a last cell in the message block includes 8 bytes of overhead in its payload. The 8 bytes of overhead include an end of message indication and a message Cyclical Redundancy Check (“CRC”) value. Additionally, there are operations and maintenance (OAM) cells used to provide various maintenance functions within the ATM network, including connectivity verification and alarm surveillance. Operation and maintenance cells (OAM cells) and resource management cells (RM cells) are 53 bytes, but have logical structures different from the logical structure of the data cells 200.

A stream represents a communication from a source device, such as a computer, to a destination device. The ATM protocol is capable of administering the transmission of up to approximately 2²⁸ streams at a time and the cells 200 that make up each unique stream may be transmitted at different rates. The cells 200 that comprise the stream are sent sequentially in time, but may be sent at any rate and at any time. Cells 200 from different streams are interleaved with each other as well as OAM and RM cells during transmission. The ATM protocol is capable of multiplexing up to approximately 2²⁸ full-duplex streams on a single channel. In order to administer and reassemble the different streams, an ATM switch assigns a unique stream identifier as part of an ATM segmentation process. The stream identifier comprises two numbers that are referred to as a Virtual Path(“VP”)/Virtual Channel (“VC”) pair. The VP/VC pair is referred to herein as the stream identifier. The stream identifier is placed in the header of the ATM cells that carry data being transferred as part of the stream and provide a mechanism by which the streams are reconciled at the point of reassembly. Accordingly, in order to reassemble the cells of a stream, it is necessary to parse and interpret the header information in each cell before interpreting and disposing of the payload. For ATM Switched Virtual Circuits (SVCs), at some point in time, the stream finishes, the data transfer is complete, and the stream number is no longer relevant to the communication process. ATM Permanent Virtual Circuits (PVCs) streams do not finish unless manually removed.

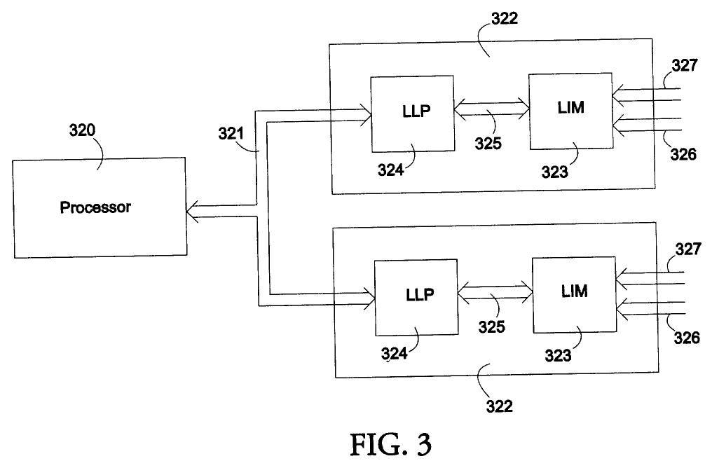

With specific reference to FIG. 3 of the drawings, a test device 107 according to the teachings of the present invention comprises a processor such as a personal computer 320 or equivalent communicating over a communications bus 321 to one or more electronic printed circuit boards (“PCB”) 322. In the embodiment illustrated, the processor 320 and PCBs 322 share a chassis and power supply. The illustration shows two PCBs. The number of PCBs, however, is dictated by a user's need and limited by a physical capacity of the chassis. In an alternate embodiment, the internal communications bus may be an external LAN where the processor 320 is remote from the other hardware elements. Each printed circuit board 322 contains a line interface module (“LIM”) 323 and a link layer processor (“LLP”) 324. The LIM and the LLP communicate over an internal communications bus 325. The circuitry on each of the PCBs is the same. Each PCB, however, independently processes different network data. Therefore, only the structure of one PCB is further described.

The PCB 322 has two channels. A first channel 326 is connected to the cable 100 carrying incoming cells 200 and a second channel is connected to the cable 110 carrying outgoing data 327. In a specific embodiment, there is a plurality of different LIMs 323 for connections to different types of ATM networks. As an example, a PCB for connection to an optical ATM network has a different configuration and physical connector than that for a connection to an electrical network. The logic contained in the PCBs, however, remains the same. Generally, the LIM 323 comprises hardware circuitry that receives and processes individual cells 200 as they are presented on the network. The LLP 324 comprises processing hardware and software executing on the processing hardware that performs high level analysis functions related to the network data. In describing a preferred embodiment according to the teachings of the present invention, functions involved in data network processing are executed on the combination of LLP and LIM in hardware, software, or a combination of both. As one of ordinary skill in the art can appreciate, there are obvious alternatives for performing the functions described herein that are not specifically described that utilize a different assignment of hardware and software functions. Such obvious alternatives are within the scope of the present invention.

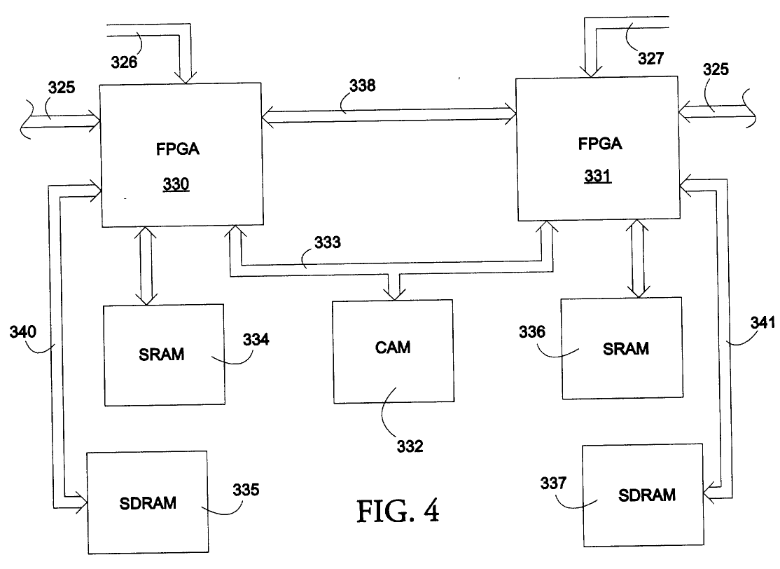

With specific reference to FIG. 4 of the drawings, there is shown a block diagram for the line interface module (“LIM”) 323 present on the PCB 322. The LIM comprises first and second field programmable gate arrays (“FPGAs”), 330 and 331 respectively, that receive and process network data from the first and second channels 326, 327. Logic in the FPGAs 330, 331 controls different electronic processes that perform the functions of the tester. The FPGAs are encoded with a front-end tool using a PC running Microsoft's Windows 2000 operating system and applications from Synplicity including a VHDL language and the SynplifyPro compiler/synthesizer software package. A back-end tool includes Foundation software from Xilinx.

The first and second FPGAs communicate with each other over an FPGA bus 338 and are connected to a single content addressable memory (“CAM”) 332 over a shared CAM bus 333. The first FPGA 330 is also connected to a dedicated first SRAM 334 and first SDRAM 335 memory elements. Similarly, the second FPGA 331 is connected to a dedicated second SRAM 336 and second SDRAM 337 memory elements. The first and second SRAM memory elements 334, 336 are identical in size and specifications. Each SRAM memory element 334, 336 comprises a 512 kbyte part having an 18-bit address bus. Each SRAM memory element 334, 336 is 16-bits wide and 256 k entries deep, but is logically separated into a scratchpad area, a per-channel data storage area, a global header storage area, per-stream status information field, an A memory element and a B memory element. The A and B memory elements store network performance data for the data network under test according to the teachings of U.S. patent application Ser. No. xx/xxx,xxx (Agilent PDNO 10020657) filed Oct. 4, 2002 entitled “Method and Apparatus for Testing a Data Network” having inventor Charles Burnett in common with the present patent application and is hereby incorporated by reference.

The LIM 323 eavesdrops on the ATM network, via channels 326 and 327, in both the receive and transmit directions, parses the header 201 from the payload 202 of each cell 200, determines to which stream the cell belongs, determines if a particular stream is being tracked, gathers network performance data by counting events, calculating statistics or calculating error check products, such as a Cyclical Redundancy Check (“CRC”) product for the stream over a given period of time, stores the network performance data into the SRAMs 334, 336, and stores cells according t( stream identifier in a buffer manager process. Advantageously, many of the possible options to collect, process, and view the data are user selectable.

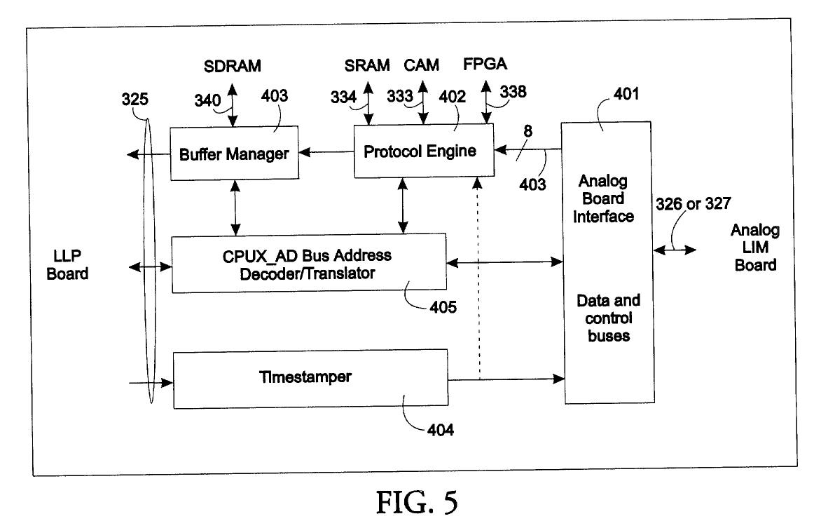

With specific reference to FIG. 5 of the drawings, there is shown a block diagram of one of the FPGAs 330, 332 on the LIM 323. Both FPGAs 330, 332 have an identical structure. Accordingly, only one FPGA is described. The arrows in the diagram show the majority of the data flow, but do not preclude some reverse control information and other minor functions. The FPGAs 330, 332 comprise an analog interface block 401 that receives network data presented on the incoming and outgoing channels 326, 327. The analog interface block 401 receives the data on a bit for bit basis from a network cable and frames the bits into 8-bit ATM bytes that comprise the cell 200. The analog interface block 401 then sends each framed byte to protocol engine 402 over a framing bus 403. The protocol engine 402 performs most of the administrative, decision and processing functions done by the FPGAs 330, 332. The protocol engine 402 also communicates with a buffer manager 403. The buffer manager 403 receives a data byte and a CAM index 613 from the protocol engine. The buffer manager 403 determines an address offset and writes the received data to the appropriate location in the SDRAM 335 or 337 based upon the CAM index 613 given to the buffer manager 403 by the protocol engine 402 at the same time it gives the data byte for storage. The FPGA 332 or 330 also includes a timestamper 404 and CPUX-AD Bus Address Decoder/Translator 405. The CPUX-AD Bus Address Decoder/Translator performs communication administration between the LIM 323 and the LLP 324. Within the FPGAs 330, 332 there is also some internal memory. Some of the internal memory comprises a SAR engine configuration register (not shown in the drawings).

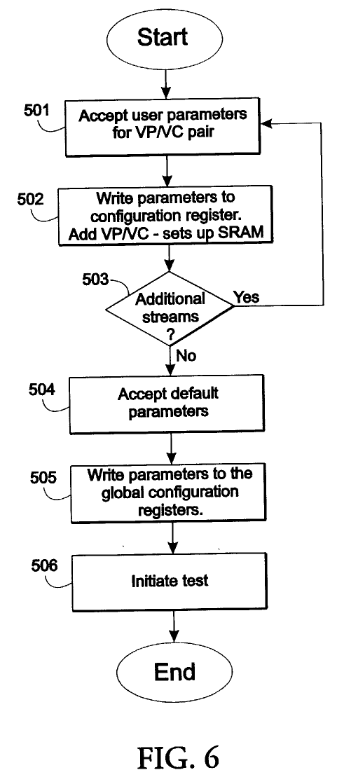

With specific reference to FIG. 6 of the drawings, there is shown a flow diagram for a graphical user interface (“GUI”) running on the processor 320 in which a user inputs parameters 501 for each VP/VC pair that is of interest. Specifically, a user indicates whether the VP/VC pair is to be reassembled or not, and if so, which adaptation layer to use for the reassembly. Possible adaptation layers are defined by the ATM specifications and are referred to as AAL-5, AAL-3/4, AAL-2, and AAL-1. When input into the GUI, the processor 320 executes commands to the 32-bit SAR engine configuration register to indicate an adaptation layer for new streams added through a software request. Each channel on the LIM has the SAR engine configuration register. Accordingly, there are two parallel, but separately programmable SAR engine configuration registers. An ADD command is then issued with the stream identifier as an argument to the ADD command. The ADD command results in a write 502 of the stream specific information into a configuration field of the SRAMs 334, 336. The user input process is repeated 503 for all streams of interest to the user. Advantageously, the two-step process permits run-time additions of streams for tracking using the write to the SAR engine configuration register and the ADD command. Upon finalization of the streams of interest, the user further specifies 504 certain global parameters that are used for processing streams that are not identified by the user. The global parameters include one of three modes; discovery mode, no discovery but with tracking mode, and no tracking mode. Discovery mode is when the tester identifies new streams and automatically begins to monitor and collect per stream network performance data. No discovery but with tracking mode is when the tester does not identify new streams, but monitors and collects per stream network performance data on the user specified streams. The SAR configuration register contains a field for specifying an adaptation layer for those streams added by a user by way of the GUI, either pre-run time or during run-time. The SAR configuration register also contains another field for specifying an adaptation layer for those streams added when they are discovered automatically. Advantageously, streams added by a user may use a different ATM adaptation layer from streams added by the hardware as they are discovered. The “no tracking mode” does not collect any per stream network performance data and does not perform reassembly on any streams. In this mode, the tester passes all cells received by the LIM to memory for potential viewing by a user. Per stream network performance data may be any measurement parameter specific to a single stream. Examples of per stream network performance data include number of cells in the stream, number of cells subject to discard, and a number of OAM cells in the stream. The global configuration parameters further include an aging parameter that indicates how long a stream may be inactive before being removed from tracking, whether to correct header errors, whether discovered streams are to be reassembled, and if so, which adaptation layer to use for reassembly, whether user added streams are to be reassembled, and if so, which adaptation layer to use for reassembly. The global configuration parameters are represented in the LIM 323 as one or more bits stored in in internal memory located in the FPGAs 330 and 332, respectively that are read and used as needed by the processes performed in the FPGAs 330 and 332. The processor 320 writes 505 the global configuration parameters into two 32-bit configuration registers located on the LIM 323. Two identical, but separately programmable global configuration registers are present for each channel on the LIM 323. A user then initiates 506 testing under the programmed conditions. The process is described as a graphical user interface. However, a GUI may be replaced with some other process of parameter specification without departing from the scope of the present invention.

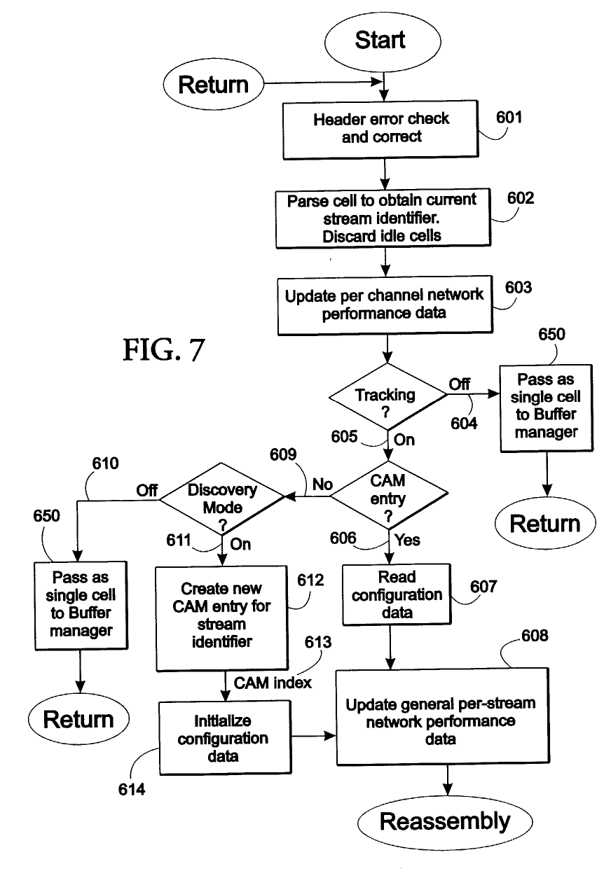

With specific reference to FIG. 7, there is shown a flow chart of a cell administration process that is performed on each cell 200 that is presented on the network under test. If header error correction (“HEC”) is enabled, logic in the protocol engine of the LIM 323 performs the HEC function 601, incrementing a HEC counter if a header error is detected. HEC is conventional in the art and is described in the ATM specification documents. A next operation is to parse 602 the cell 200 to obtain a current stream identifier. The cell 200 comprises 53 bytes, 5 bytes of header 201 and 48 bytes of payload 202. The stream identifier is a concatenation of the binary VP/VC pair, which is located in the header 201. The header 201 also contains information that indicates whether the cell is an idle cell, i.e. one that carries no information. If so, the protocol engine 402 of the LIM 323 increments an idle cell counter and then immediately discards the idle cell without further processing. For each cell, additional per-channel network performance data are collected. The per-channel network performance data include the total number of idle cells and the number of header errors, as mentioned previously, but also a number of OAM/RM cells and a number of non-idle, non-OAM/RM cells. The per-channel data for each channel are stored 603 in a portion of the appropriate SRAMs 334/336. The per-channel network performance data is useful and may be read and used by the LLP 321 to calculate channel performance indicia. For example, the number of OAM/RM cells plus the number of non-idle/non-OAM/RM cells divided by the total number of cells yields the line rate of the channel.

If the system is configured in a no tracking mode 604, then the protocol engine 402 sends the bytes of the cell 200, one by one, to the buffer manager 403 with a CAM index of 1 FFFhex. Under a tracking mode, a valid CAM index value falls between 0 and FFFhex. Accordingly, the 1 FFFhex value of the CAM index 613 is an indication to the buffer manager logic that the byte received by the buffer manager is to be written to the SDRAM 335 or 337 as a single cell and not collected as part of a message in a stream.

If the system is configured in a tracking mode 605, with or without automatic discovery, the process proceeds to identify whether network performance data is already being kept for the current stream identifier. In a preferred embodiment, making a request of the CAM to return an index value if the stream identifier matches data already stored in the CAM performs this function. Additional details concerning the function and use of the CAM 332 are found in U.S. patent application entitled “Method and Apparatus for Efficient Administration of Memory resources in a Data Network Tester”, U.S. patent application Ser. No. xx/xxx,xxx, having inventor Charles Burnett in common with the present patent application and having Agilent PDNO 10020658 filed Oct. 10, 2002, which is hereby incorporated by reference. If the CAM returns an index value 606, the process accesses 607 the configuration data and network performance data for the stream that is related to the returned index value. Per-stream network performance data is then updated and stored 608 in the SRAM 334, 336 at the appropriate location. If the current stream identifier is not found 609 in the CAM 332 and if discovery mode is off 610, the process proceeds to send the cell data to the Buffer Manager process 650 with a CAM index of 1 FFFhex, as previously described. If the current stream identifier is not found 609 in the CAM 332 and discovery mode is on 611, a new entry is created 612 in the CAM 332. The new entry in the CAM stores the stream identifier of the current stream and returns a CAM index 613. The CAM index 613 is an address in the CAM 332 where the current stream identifier is stored and is related to an address in the SRAMs 334, 336 where configuration data and network performance data for the current stream is stored. The relationship of the CAM index 613 to SRAM address is further described in the xx/xxx,xxx patent application (Agilent docket no. 10020658). Briefly, the CAM index 613 multiplied by 16 plus an offset yields the starting address of a block of SRAM 334, 336 memory that stores data for the current stream. After the CAM entry is created, per-stream configuration information is stored 614 in the configuration field of the SRAM 334 or 336 to initialize the configuration field in preparation for receipt of per-stream network performance data. The process then continues to update 608 the per-stream network performance data in the SRAM 334 or 336 before proceeding to the reassembly process.

The SDRAMs 335, 337 on the LIM 323 are used in the tracking and reassembly process. Each SDRAM 335, 337 comprises 32 Mbytes of memory. Some of the memory is reserved for maintenance of overhead information and the remainder is divided into 1024 equally sized storage blocks. As has been mentioned herein, a preferred embodiment of the tester is able to track per-stream network performance data on up to 4096 different streams. The upper limit for cell reassembly is 1024 streams. Accordingly, the tester is able to collect and maintain per-stream network performance data for more streams than it can reassemble. As one of ordinary skill in the art will appreciate, although not disclosed as a preferred embodiment, this limitation may be overcome and scaled with the addition of more SDRAM memory 335, 337. The overhead information in each SDRAM 335, 337 includes a reassembly table mapping the CAM index to a physical address in the SDRAM for storage of a next cell.

The SRAM 334, 336 contains stream specific configuration information as well as stream specific network configuration data. Each entry in the CAM 332 has an associated 256-bit area of memory, or data block, located in the SRAM 334, 336. As mentioned herein, there are a total of 4096 possible CAM entries, and therefore, there are 4096, 256-bit data blocks. Accordingly, 131,072 bytes of memory are used for each stream-specific data block. Each data block is defined to contain bits that represent the following information:

Whether the entry is empty or contains valid network performance data (valid data bit).

Whether the entry has been acknowledged by the LLP or not.

Whether the related stream is to be reassembled.

If the stream is to be reassembled, what adaptation layer to use, the total number of messages (PDUs) in the stream, and the total number of CRC errors.

If the stream is not to be reassembled, the total number of AAL-5 end of message bits in the stream.

The stream identifier value, i.e. VP/VC pair.

The total number of cells in the stream (cell count).

The total number of cells subject to discard.

The total number of OAM cells.

Also stored in the SRAM 334, 336 is stream specific status information. Specifically, there are 4096 32-bit entries that provide the number of bytes received for the current message in the stream and a message flag. Each entry relates to an entry located in the CAM 332 for which network performance data are being collected. The per-stream status information field includes data that represent the number of bytes received for the current message and a message flag that indicates whether the current cell 200 is the start of an ATM message, or PDU, or whether it is part of a message that is already being collected. If the message flag has a value of “continue”, collection of a message is in progress. If the message flag has a value of “start”, collection of a message is not yet in progress.

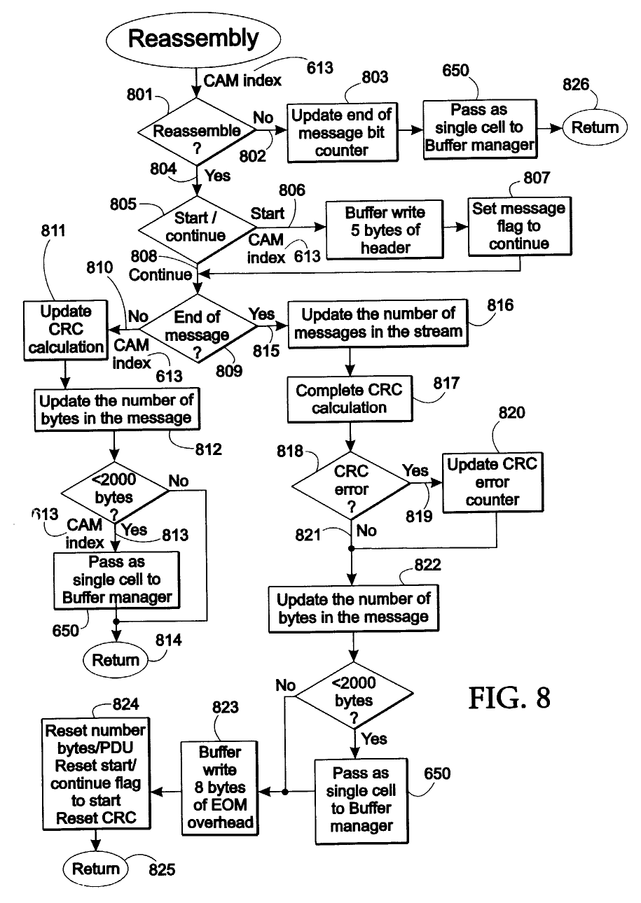

With specific reference to FIG. 8 of the drawings, there is shown a flow chart illustrating a reassembly process according to the teachings of the present invention in which a first step is to determine whether a current stream identifier is to be reassembled 801. If not 802, the cell 200 is parsed to identify whether an end of message indication is contained therein. If an end of message is contained within the cell 200, an end of message bit counter for the stream is incremented and stored 803 in the appropriate stream specific data block in the SRAM 334 or 336. Because the cell is not being reassembled, the cell 200 is passed to the Buffer Manager with the 1 FFFhex CAM index value. When the cell 200 is written to the SDRAM 335 or 337, the process returns 826 to process the next cell 200 presented to the network.

If the cell is to be reassembled 804, the system checks 805 the start/continue flag for the current stream. If the start/continue flag is set to a “start” value 806, 5 bytes of header are sent to the Buffer Manager 650 together with the CAM index 613 for storage in the SDRAM 335 or 337. When all bytes are sent, the system sets 807 the message flag to a “continue” value in preparation for receipt of the next cell of the message for that stream. When the header information is written, the process continues as if the message flag has a “continue” value 808. The process then checks 809 for an end of message indication in the cell 200. If there is no end of message indication 810, the system calculates a CRC product based upon the data in the cell for the message in progress on the stream, and stores the CRC product in the appropriate location in the SRAM 334, 336 as specified by the CAM index 613. The system then reads a value from the SRAM that specifies the number of bytes in the current message, increments the value counter by the number of payload bytes present in the cell 200, and stores 812 the updated value back into the SRAM 334, 336. The appropriate location in the SRAM 334, 336 is also based upon the CAM index 613. If 813 the total number of bytes in the message is less than or equal to 2000, then the bytes that comprise the current cell are sent to the buffer manager 650 along with the CAM index 613 for up to a total of 2000 payload bytes in the message for storage into the SDRAM 335 or 337. In a preferred embodiment, a total of 5 bytes of header overhead, 2000 payload bytes, and 8 bytes of end of message overhead are stored for each message that is reassembled in the SRDAMs 335, 337. If there are more than 2000 bytes in the current message, then the bytes are not sent to the buffer manager and are not stored in the SDRAM 335 or 337. If the number of bytes in the cell causes the total number of bytes to exceed the 2000 byte limit, the bytes of data greater than the 2000 limit are truncated and are not sent to the buffer manager. The process then returns 814 to the beginning to process a next cell presented to the network. If the cell included 815 an end of message indication, the number of messages in the stream is read from the SRAM based upon the CAM index 613, incremented by one, and then stored in the same location 816. The system then completes 817 the CRC product for the message and checks 818 for a CRC error. If a CRC error has occurred 819, the system reads the CRC error counter from the per-stream data in the SRAM, increments it, and stores 820 the updated value to SRAM 334 or 336. If a CRC error has not occurred 821 or after the CRC error counter is updated, the system proceeds to update the number of bytes in the current message 822. The same truncation occurs for messages that are greater than 2000 bytes as previously described. When the message bytes are written or not to the buffer manager, the process then sends 823 8 bytes of end of message overhead to the buffer manager for storage in the SDRAM 335 or 337 at the end of the collected message. When the message is fully written to the SDRAM, the process resets the pre-stream data in the SRAM 334 or 336. Specifically, the number of bytes in the current message is reset to zero, the message flag is reset to a “start” value, and the stream specific CRC product is reset to zero 824. The process then returns 825 to process the next cell presented to the network.

The protocol engine 402 initiates the buffer write process 650 for the purpose of writing data to the SDRAM 335 or 337. The SDRAM is logically partitioned into, a message table, a complete message list, and 1025 separate message blocks. Each message block accepts a message from one of the streams designated as being reassembled, up to a total of 1024 messages. The extra message block is designated as the message block that receives data from streams that are being tracked, but not reassembled. In this case, the data is passed as a pure cell, i.e. multiple cells are not reassembled, but are stored and presented to a user on a single cell basis.

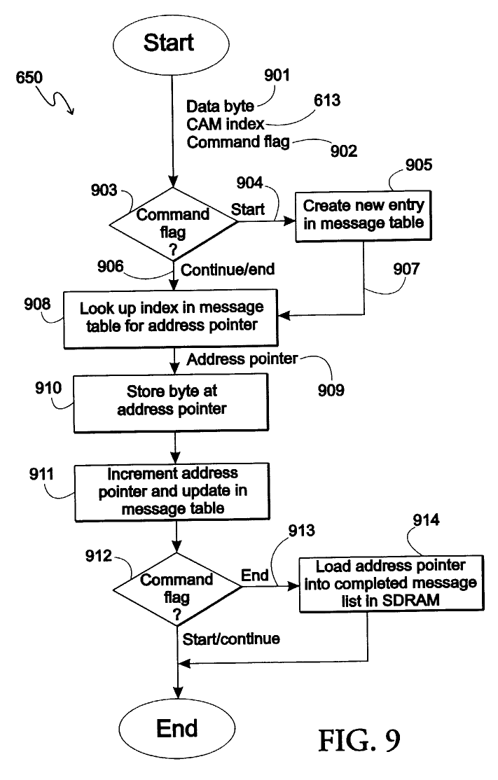

With specific reference to FIG. 9 of the drawings, there is shown a flow chart of the buffer write process 650 performed by the buffer manager 403. The protocol engine 402 initiates the write process for each byte destined for storage in the SDRAM 335 or 337. The protocol engine 402 passes an 8-bit data byte, a 13-bit CAM index 613, and a 2-bit command flag 902. The CAM index 613 that is passed to the buffer manager 403 includes an extra bit. That extra bit is a pure cell indication and if it is true, the buffer manager 403 processes the byte passed to the buffer manager 403 in the same way as other bytes stored to the SDRAM, but it is stored in a message block in the SDRAM dedicated to the pure cell special case. The buffer manager 403 maintains the message table in the SDRAM 335 or 337. The message table maps CAM indexes 613 to an address pointer that indicates the location in SDRAM memory that is to receive the next byte. The CAM index having the pure cell bit set to an affirmative value has a dedicated message block in SDRAM 335 or 337. When the buffer write process is initiated, the first step is to evaluate 903 the command flag 902. The command flag 902 indicates one of three possible states; start, continue and end. If the command flag 902 reflects a “start” value 904, the buffer manager 403 creates 905 a new entry in the message table by identifying an unused message block and writing the CAM index 613 to the message table with the appropriate address pointer. If the command flag reflects a “continue” or “end” value 906, it means that reassembly of the current message is in progress and the CAM index 613 is already part of the message table. Accordingly, after creation of the new message table entry 907 or when the command flag reflects a value other than “start”, the buffer manager 403 proceeds to look up 908 the CAM index 613 in the message table. The look up process returns the address pointer 909 and the buffer manager 403 stores 910 the data byte 901 at the SDRAM location designated by the address pointer 909. The process then increments 911 the address pointer 909 and updates the message table with the new address pointer value. The buffer manager 403 then evaluates 912 the command flag 902. If the command flag reflects an “end” value 913, then the data byte is the last byte for the current message. Accordingly, the buffer manager 403 stores 914 a start address pointer for the current message into a completed message list in the SDRAM 335 or 337 as well as the number of bytes stored in the message. After updating the completed message list or if the command flag 902 does not reflect an “end” value, the process then proceeds to an end. The buffer write process 650 executes for each byte stored in the SDRAM 335 or 337.

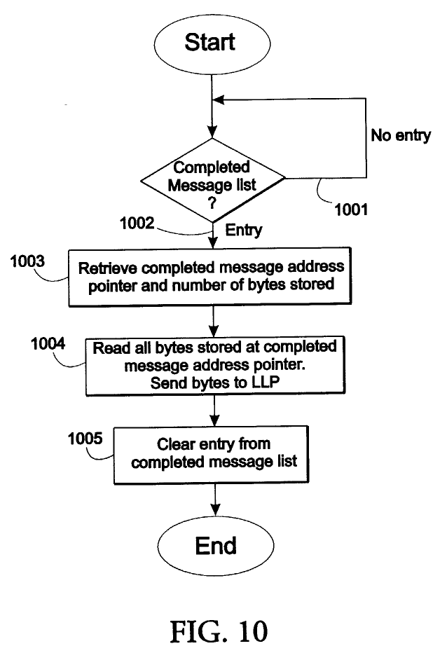

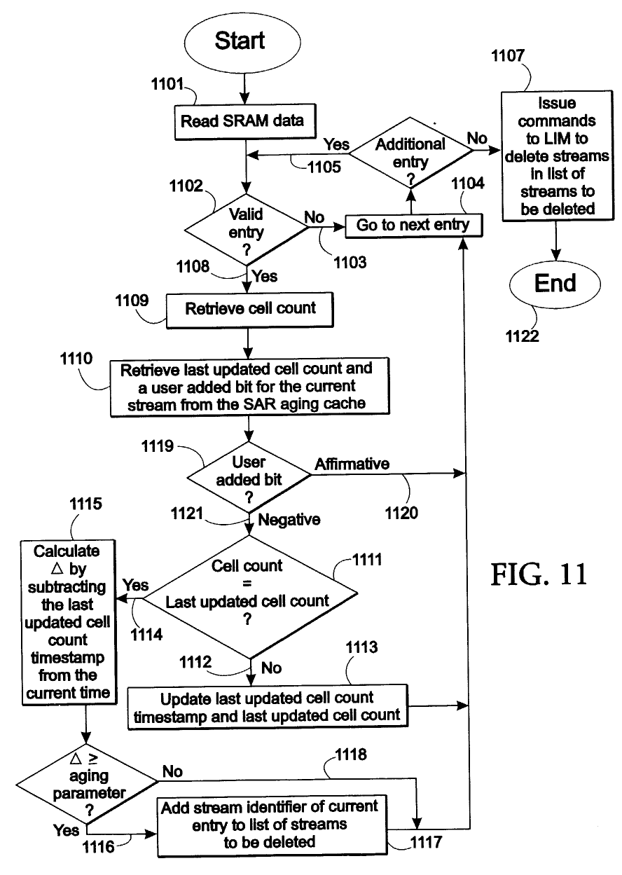

With specific reference to FIG. 10 of the drawings, there is shown a flow chart of a buffer read process executed by the buffer manager 403 that alerts the LLP 324 that a message block has been reassembled and is ready for transfer to the LLP 324. The buffer manager 403 executes the buffer write and the buffer read processes in parallel. The buffer read process simply waits 1001 until an entry exists in the completed message list. When an entry is detected 1002, the buffer read process retrieves 1003 a completed message address pointer and a number of bytes stored in the message block. The buffer read process then accesses and reads 1004 all bytes stored at the completed message address pointer and sends the bytes to the LLP 324. The entry in the completed message list is then cleared before the buffer read process ends. The LLP 324 performs capture filtering on the data retrieved from the SDRAM 335 or 337. Capture filtering is the identification and collection of data based upon information content of the reassembled messages, i.e. the collection of cell payloads related to a single stream. Capture filtering can also perform interpretation of the messages based upon higher level protocols. There is a challenge presented by real-time collection of data on a high-speed data network. The challenge is the tremendous amount of data from which information is sought. In many cases, it is necessary to analyze a large amount of data before any of the data may be understood. Under current processing capabilities, it not only takes a large amount of memory, it is extremely difficult to perform real-time content based filtering on all data present on a high-speed data network. Performing reassembly prior to content based filtering significantly reduces the amount of data that must be captured, stored, and interpreted in the content based filtering step. The reassembly essentially pre-filters and performs preliminary capture before further capture filtering is performed. Additionally, the LLP performs multiframe correlation and analysis on the data, the specifics of which are beyond the scope of the present disclosure. The LLP 324 also passes the data along to the processor 320 for further higher level decode and interpretation. With specific reference to FIG. 11 of the drawings, there is shown a flow diagram for an aging detection process according to the teachings of the present invention in which streams that have been discovered and for which there has been no network activity for a period of time as specified by the user are removed from tables kept in the LIM 323. Streams that are specified for tracking or tracking and reassembly by the user are not aged. Advantageously, the removal process permits memory resources to be used and reused for active streams. The aging detection process is performed in the LLP 324 every second in time for each channel on the LIM 323. There is a timer on the LLP 324 that regulates how often the aging detection process is initiated. The aging detection process begins by reading 1101 the network performance data and per-stream configuration information from the SRAM 334 or 336. The process evaluates 1102 the valid data bit for each data block in the SRAM 334 or 336. If the data stored in the data block is not valid 1103, the process increments 1104 a pointer to evaluate a next entry. If the updated pointer refers to another entry 1105, the process repeats for the next entry. If the updated pointer does not refer to another entry 1106, the aging detection process is complete. If the valid data bit is affirmative 1108, the process retrieves the cell count 1109, which reflects a number of cells in the current message. The software in the LLP 324 maintains a cell count table where a stream identifier is indexed to a last updated cell count, a cell count timestamp and also indicates whether the stream was user added or discovered. The process retrieves 1110 the last updated cell count value from the table and then checks 1119 a user added bit to determine if the current entry is a user added stream or a discovered stream. If the user added bit is affirmative 1120, the process for the current entry ends and proceeds to 1104 to evaluate the next entry in the list. If the user added bit is negative 1121, the process compares 1111 the last updated cell count against the cell count. If the cell count is different from the last updated cell count 1112, the process updates 1113 the cell count table with a current timestamp stored as the cell count timestamp and the last updated cell count with the cell count value. If the cell count is the same as the last updated cell count 1114, the process calculates 1115 a difference between a current time and the cell count timestamp. If the difference is greater than or equal to the value in the user specified aging parameter 1116, the LLP 324 adds an entry to a stream delete table and the process continues with evaluation of the next entry 1104. If the difference is not larger than the aging parameter 1118, the cell count table is not updated and the process proceeds to evaluate a next entry 1104. When all entries are evaluated, the process uses the stream delete table and issues 1107 one or more delete commands to the LIM 323. The delete command is issued one at a time in a local loop within the LLP software with the stream identifier as an argument to the delete command. When all stream identifiers in the stream delete table are processed, the aging process ends 1122.

Embodiments of the invention are described herein by way of example and are intended to be illustrative and not exclusive of all possible embodiments that will occur to one of ordinary skill in the art with benefit of the present teachings. Specifically, the teachings may be applied to any data network, not just ATM, in which continuous and real time data collection is beneficial. Specifically, the teachings of the present invention may be applied to a transmission control protocol (“TCP”) by one of ordinary skill in the art. In a TCP embodiment, the “cell” is referred to in the industry as a “packet”. The method may also be implemented in a different combination of hardware and software.

1. A method for testing a data network comprising the steps of:
establishing one or more stream identifiers for reassembly,
receiving a cell,
parsing said cell to obtain a current stream identifier,
establishing one or more message blocks in memory related to respective ones of said one or more stream identifiers for receipt of a portion of said cell and if said current stream identifier is one of said one or more stream identifiers that are established for reassembly, performing the steps of; serially writing a portion of said cell into a one of said message blocks related to said current stream identifier, and
repeating said steps of receiving, parsing and serially writing until said message block is complete.

2. A method for testing as recited in claim 1 wherein said data network is an Asynchronous Transfer Mode network.

3. A method for testing as recited in claim 1 and further comprising the step of displaying said completed message block.

4. A method for testing as recited in claim 1 and further comprising the step of performing a header error correction of said cell.

5. A method for testing as recited in claim 1 and further comprising the step of collecting network performance data for a stream related to said cell.

6. A method for testing as recited in claim 1 and further comprising the step of establishing an adaptation layer for each said one or more stream identifiers.

7. A method for testing as recited in claim 6 wherein said adaptation layer is selected from the set consisting of AAL-5, AAL-3/4, AAL-2, AAL-1 and no adaptation layer.

8. A method for testing as recited in claim 7 wherein if no adaptation layer is established, using an AAL-5 adaptation layer.

9. A method for testing as recited in claim 1 wherein said stream identifier comprises a concatenation of an ATM virtual path, virtual circuit pair.

10. A method for testing as recited in claim 1 and further comprising the step of removing one or more entries from said stream identifiers of interest.

11. A method for testing as recited in claim 10 and further comprising the step of establishing a timeout value for each one of said stream identifiers of interest and wherein said step of removing occurs in response to the absence of a cell within a time specified by said established timeout value.

12. A method for testing as recited in claim 1 and further comprising the step of filtering data in said message block after said step of serially writing until said message block is complete.

13. An apparatus for testing an asynchronous transfer mode (“ATM”) data network comprising:
a line interface module,
a link layer processor,
a graphical user interface in communication with said link layer processor permitting entry of one or more stream identifiers of interest,
means for receiving a cell,
means for parsing said cell to obtain a current stream identifier,
means for establishing one or more message blocks in memory related to respective ones of said one or more stream identifiers for receipt of a portion of said cell, and
means for serially writing a portion of said cell into a one of said message blocks related to said current stream identifier.

14. An apparatus for testing as recited in claim 13 wherein said data network is an Asynchronous Transfer Mode network.

15. An apparatus for testing a data network as recited in claim 13 and further comprising means for performing a header error correction of said cell.

16. An apparatus for testing a data network as recited in claim 13 and further comprising means for collecting network performance data for a stream related to said current cell.

17. An apparatus for testing a data network as recited in claim 13 and further comprising the means for establishing an adaptation layer for each said one or more stream identifiers.

18. An apparatus for testing a data network as recited in claim 17 wherein said adaptation layer is selected from the set consisting of AAL-5, AAL-3/4, AAL-2, AAL-1 and no adaptation layer.

19. An apparatus for testing a data network as recited in claim 18 wherein if no adaptation layer is established, an AAL-5 adaptation layer is used.

20. An apparatus for testing a data network as recited in claim 13 wherein said stream identifier comprises a concatenation of an ATM virtual path, virtual circuit pair.

21. An apparatus for testing a data network as recited in claim 13 and further comprising means for removing one or more entries from said stream identifiers of interest.

22. An apparatus for testing a data network as recited in claim 21, said graphical user interface further permitting entry of a timeout value for each one of said stream identifiers of interest.

23. An apparatus for testing as recited in claim 13 and further comprising means for filtering data in a completed message block based upon content based criteria.
